(19) United States
(12) Patent Application Publication
(10) Pub. No.: US 2007/0182691 A1
(43) Pub. Date: Aug. 9, 2007

(54) Liquid crystal display and method thereof

(76) Inventor: Byoung-sun Na, Suwon-si (KR)

Correspondence Address: CANTOR COLBURN, LLP, 55 GRIFFIN ROAD SOUTH, BLOOMFIELD, CT, 06002, US

(21) Appl. No.: 11/493,333

(22) Filed: Jul. 26, 2006

(30) Foreign Application Priority Data
Jul. 26, 2005 (KR) 10-2005-0067989

(51) Int. Cl. G09G 3/36

(52) U.S. Cl. 345/100

(57) ABSTRACT

A liquid crystal display (“LCD”) device which is capable of improving display characteristics by preventing horizontal stripes from being generated thereon is provided. The LCD includes a liquid crystal panel displaying image data, a plurality of gate integrated chips (“ICs”) connected to a first side of the liquid crystal panel, a plurality of data ICs connected to a second side of the liquid crystal panel, the second side of the liquid crystal panel adjacent to the first side of the liquid crystal panel, a gate voltage generation unit providing one of a gate-on voltage and a gate-off voltage to the gate ICs, and a plurality of gate driving signal transmission lines connecting the gate voltage generation unit and the gate ICs and connecting the gate ICs to one another, wherein a resistance of the gate driving signal transmission line connecting the gate voltage generation unit and the gate IC closest to the gate voltage generation unit is higher than a sum of resistances of remaining gate driving signal transmission lines.

This application claims priority to Korean Patent Application No. 10-2005-0067989, filed on Jul. 26, 2005 and all the benefits accruing therefrom under 35 U.S.C. §119, and the contents of which in its entirety are herein incorporated by reference.

### BACKGROUND OF THE INVENTION

1. Field of the Invention

The present invention relates to a liquid crystal display (“LCD”) and method thereof, and more particularly, to an LCD with improved display characteristics and a method of improving display characteristics of the LCD.

2. Description of the Related Art
Cathode ray tubes (“CRTs”), which are one type of generally used displays, are widely used in televisions, monitors for instrumentation systems, and information terminal devices. However, the CRT is not suited to the demands for miniaturized, light-weight electronic products due to its own weight and size.

To substitute CRTs, LCDs have been actively researched. The LCDs have some notable advantages, such as small size, light weight structure, low power consumption and low driving voltages, and are capable of displaying information using electrical and optical properties of liquid crystals injected into a liquid crystal panel. Due to such advantages, LCDs are being actively researched and developed. Recently, LCDs have become the mainstream of the current flat display devices and are used in a wide variety of applications such as portable computers, desktop computer monitors, monitors of high-quality image display devices, and the like.

In recent years, as electronic products, such as mobile phones, personal digital assistants (“PDAs”), LCDs, notebook computers, and the like are moving towards miniaturization, slimness and lighter weight structures, features including reduction in size and weight, high function, high performance, and high density are increasingly demanded in a variety of parts of such electronic products including semiconductor chips mounted thereon.

LCDs are being developed to be implemented as one-chip integrated circuits or chips (“ICs”) without forming a gate printed circuit board (“PCB”).

In order to reduce manufacturing costs of LCDs, numbers of output channels of a data IC and a gate IC for driving a liquid crystal panel have steadily increased. For example, the number of output channels of a data IC which provides a super extended graphics array (“SXGA”) resolution has increased from 384 to 643, and the number of output channels of a gate IC has increased from 256 to 342, in which case, a total number of data ICs and a total number of gate ICs required by an LCD can be reduced from 10 to 6 and from 4 to 3, respectively.

However, in the case of a conventional LCD from which a gate PCB is removed, the greater the distance among a plurality of gate ICs, the greater the length of gate driving signal transmission lines connecting the gate ICs from one another, and the higher the resistance of the gate driving signal transmission lines. As the resistance of the gate driving signal transmission lines increases, a common voltage and a gate-off voltage are likely to be distorted while being transmitted from one gate IC to another. Therefore, horizontal stripes may be formed among a plurality of gate lines connected to respective corresponding gate ICs.

### BRIEF SUMMARY OF THE INVENTION

Exemplary embodiments of the present invention provide an LCD capable of improving display characteristics by preventing horizontal stripes from being generated.

Exemplary embodiments of the present invention also provide a method of improving display characteristics of an LCD by preventing horizontal stripes from being generated.

The above and other features and advantages of the present invention will become clear to those skilled in the art upon review of the following description.

According to exemplary embodiments of the present invention, there is provided an LCD device including a liquid crystal panel displaying image data, a plurality of gate ICs connected to a first side of the liquid crystal panel, a plurality of data ICs connected to a second side of the liquid crystal panel, the second side of the liquid crystal panel adjacent to the first side of the liquid crystal panel, a gate voltage generation unit providing one of a gate-on voltage and a gate-off voltage to the gate ICs, and a plurality of gate driving signal transmission lines connecting the gate voltage generation unit and the gate ICs and connecting the gate ICs to one another, wherein a resistance of the gate driving signal transmission line connecting the gate voltage generation unit and the gate IC closest to the gate voltage generation unit is greater than a sum of resistances of remaining gate driving signal transmission lines.

According to other exemplary embodiments of the present invention, there is provided an LCD device including a plurality of gate ICs and a gate voltage generation unit connected to a first gate IC, and connected to a remainder of the plurality of gate ICs via the first gate IC, wherein a resistance between the first gate IC and the gate voltage generation unit is greater than a sum of resistances of connections between adjacent gate ICs.

According to other exemplary embodiments of the present invention, there is provided a method of improving display characteristics of an LCD including arranging chip-interconnecting gate driving signal transmission lines between adjacent gate ICs, and providing a connection between a first gate IC and a gate voltage generation unit with a resistance greater than a sum of resistances of the chip-interconnecting gate driving signal transmission lines.

### BRIEF DESCRIPTION OF THE DRAWINGS

The above and other features and advantages of the present invention will become more apparent by describing exemplary embodiments thereof with reference to the attached drawings in which:

FIG. 1 is a block diagram of an exemplary system for driving an exemplary LCD according to an exemplary embodiment of the present invention;

FIG. 2 is a perspective view of an exemplary LCD according to an exemplary embodiment of the present invention;

FIG. 3 is a block diagram for explaining the relationships between an exemplary gate voltage generation unit of FIG. 1 and a plurality of exemplary gate integrated chips (“ICs”) of FIG. 2;

FIG. 4 is a circuit diagram of an exemplary thin film transistor (“TFT”) included in an exemplary liquid crystal panel according to an exemplary embodiment of the present invention;

FIG. 5 is a graph illustrating the variation of pixel electrode voltages for a plurality of exemplary gate ICs with different resistances between the exemplary gate voltage generation unit and the exemplary first gate IC of FIG. 3; and

FIG. 6 is a circuit diagram of an exemplary 1-dot on/off pattern according to an exemplary embodiment of the present invention.

### DETAILED DESCRIPTION OF THE INVENTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

The present invention will now be described more fully with reference to the accompanying drawings, in which exemplary embodiments of this invention are shown.

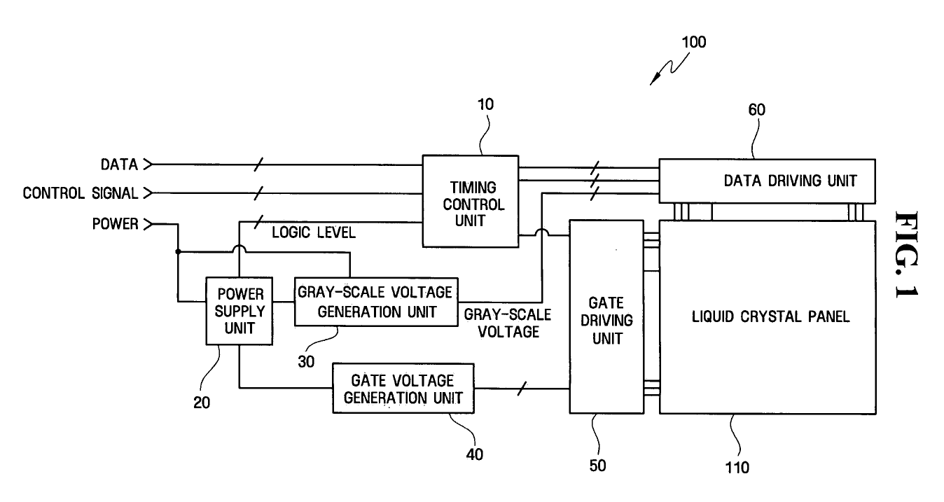

FIG. 1 is a block diagram of an exemplary system for driving an exemplary LCD according to an exemplary embodiment of the present invention. Referring to FIG. 1, in an exemplary system for driving an exemplary LCD device 100 according to an exemplary embodiment of the present invention, predetermined data and a control signal are input to a timing control unit 10, and a direct current power is provided to a power supply unit 20. When a direct current (“DC”) power is provided to the power supply unit 20, the power supply unit 20 provides a constant voltage to the timing control unit 10, the gray-scale voltage generation unit 30, and the gate voltage generation unit 40. The constant voltage is necessary for the timing control unit 10, the gray-scale voltage generation unit 30, and the gate voltage generation unit 40 to operate.

Here, the timing control unit 10 outputs first control signals and data necessary for determining a gray-scale level for each pixel of a liquid crystal panel 110 to a data driving unit 60, which is electrically connected to the liquid crystal panel 110, and outputs second control signals to a gate driving unit 50, also electrically connected to the liquid crystal panel 110.

The timing control unit 10 receives a vertical synchronization signal Vsync, a horizontal synchronization signal Hsync, a main clock signal MCLK, RGB image data, and a data enable signal DE from an external graphic controller (not shown), generates the first control signals based on the vertical synchronization signal Vsync and the horizontal synchronization signal Hsync, which are used for controlling the display of the RGB image data, and outputs the RGB image data to the data driving unit 60 together with the first control signals.

Here, the first control signals include a load signal LOAD or time proportioning (“TP”) signal and a horizontal synchronization start signal STH. The load signal LOAD or TP starts transmission to the data driving unit 60 after transmitting the RGB image data to the data driving unit 60. The horizontal synchronization start signal STH indicates the start of a scan line.

In addition, the timing control unit 10 generates the second control signals based on the vertical synchronization signal Vsync and the horizontal synchronization signal Hsync and outputs the second control signals to the gate driving unit 50.

Here, the second control signals include a gate selection signal Gat CLK or CPV which controls the outputting of a gate-on signal or a gate-off signal, a vertical synchronization start signal STV which is used for choosing a first scan line, and an output enable signal OE.

In addition, the gray-scale voltage generation unit 30 is designed to provide a gray-scale voltage to the data driving unit 60, and the gate voltage generation unit 40 is designed to provide a gate-on voltage Von and a gate-off voltage Voff to the gate driving unit 50.

The gate driving unit 50 and the data driving unit 60, which are electrically connected to sides of the liquid crystal panel 110, generate a gate signal and a source signal, respectively, and apply the gate signal and the source signal to the liquid crystal panel 110.

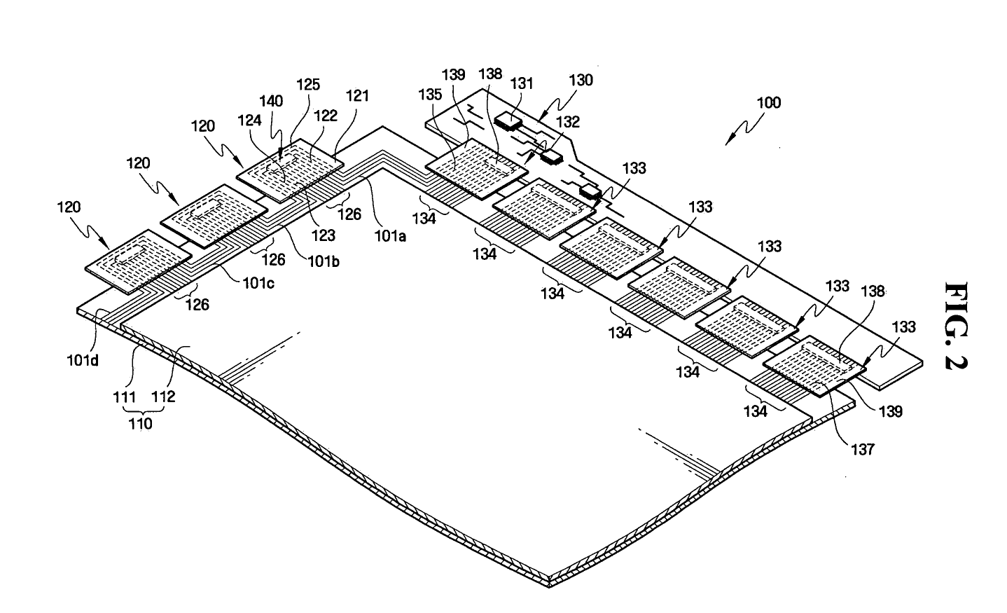

FIG. 2 is a perspective view of an exemplary LCD according to an exemplary embodiment of the present invention. An exemplary tape circuit substrate for exemplary embodiments of the present invention include, but are not limited to, a flexible printed circuit board (“FPCB”) in which wiring patterns are formed on a base film, such as a tape carrier package (“TCP”) or a chip on film (“COF”). Such tape circuit substrates are constructed with a wiring pattern layer and inner leads connected thereto formed on thin films made of an insulating material, e.g., polyimide resin. The tape circuit substrate includes prefabricated bumps and a wiring substrate for tape automated bonding (“TAB”) of the inner leads of the tape circuit substrate to a semiconductor chip. The above-referenced tape circuit substrates are used as exemplary embodiments only.

Referring to FIG. 2, the LCD 100 includes an assembly of a liquid crystal panel 110, a plurality of gate semiconductor chip packages 120, at least one first data semiconductor chip package 132, a plurality of second data semiconductor chip packages 133, and an integrated printed circuit board (“PCB”) 130.

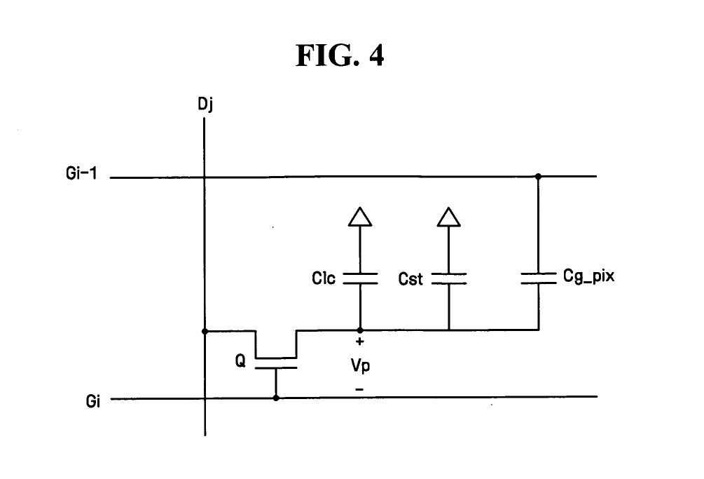

Here, the liquid crystal panel 110 includes a thin film transistor (“TFT”) panel 111 which includes a plurality of gate lines 126 extending in a first direction from the gate semiconductor chip packages, a plurality of data lines 134 extending in a second direction from the data semiconductor chip packages 132, 133, TFTs (as will be further described with respect to FIG. 4), and pixel electrodes. The liquid crystal panel 110 also includes a color filter panel 112 deposited over the TFT panel 111 to face the TFT panel 111. The color filter panel 112 is smaller than the TFT panel 111, and includes a black matrix, color pixels, and a common electrode. In addition, a liquid crystal layer (not shown) is interposed between the color filter panel 112 and the TFT panel 111.

In this case, the gate semiconductor chip packages 120 are connected to the gate lines 126 formed on the TFT panel 111, and the first and second data semiconductor chip packages 132 and 133 are connected to the data lines 134 formed on the TFT panel 111. The gate lines 126 may extend substantially perpendicular to the data lines 134, and the gate semiconductor chip packages 120 may be positioned on a first side of the TFT panel 111 that is substantially perpendicular to a second side of the TFT panel 111 on which the first and second data semiconductor chip packages 132, 133 are arranged.

The integrated PCB 130 has a plurality of driving elements 131 mounted thereon. Since the driving elements 131 are semiconductor chips designed using a typical one-chip method, a plurality of gate driving signals are input to the gate semiconductor chip packages 120 while a data driving signal is input to the first and second data semiconductor chip packages 132 and 133. The gate voltage generation unit 40 of FIG. 1 is formed on the integrated PCB 130 and provides the gate-on voltage Von and the gate-off voltage Voff to the gate semiconductor chip packages 120, as will be further described below.

Here, the gate lines 126 are spaced at regular intervals in an effective display region of the liquid crystal panel 10 where images are actually displayed, and their spacing interval decreases in a non-effective display region corresponding to the boundaries of the TFT panel 111 so that they can be divided into a plurality of groups, for example, 3 groups as illustrated in FIG. 2, and thus can be effectively connected to the gate semiconductor chip packages 120.

Likewise, the data lines 134 are spaced at regular intervals in the effective display region of the liquid crystal panel 110, and their spacing interval decreases in the non-effective display region so that they can be divided into a plurality of groups, for example, six groups as illustrated in FIG. 2, and thus can be effectively connected to the first and second data semiconductor chip packages 132 and 133.

In addition, a plurality of first gate driving signal transmission lines 101a extend between a first gate semiconductor chip package 120 and a first data semiconductor chip package 132 which are located near a comer of the TFT panel 111, defined between the first and second sides of the TFT panel 111, such that the first gate semiconductor chip package 120 and the first data semiconductor chip package 132 are adjacent to each other. One end of each of the first gate driving signal transmission lines 101a extends toward the first data semiconductor chip package 132 having data lines 134 extending therefrom, and the other end of each of the first gate driving signal transmission lines 101a extends toward the first gate semiconductor chip package 120 having gate lines 126 extending therefrom.

Second through fourth gate driving signal transmission lines 101b, 101c, and 101d may be arranged among the groups of gate lines 126 within the non-effective display region of the LC panel 110. The second through fourth gate driving signal transmission lines 101b, 101c, and 101d extend from one side of the TFT panel 111 along the respective groups of gate lines 126, are bent twice by about 90 degrees, and extend toward the side of the TFT panel 111 from which the second through fourth gate driving signal transmission lines 101b, 101c, and 101d extend to be parallel to the respective groups of gate lines 126. In other words, the second gate driving signal transmission lines 101b may extend perpendicularly with respect to the first side of the TFT panel 111 and away from the first side of the TFT panel 111, may be bent by about 90 degrees, may then extend in a direction parallel to the first side of the TFT panel 111 and between the set of gate lines 126 extending from the first gate semiconductor chip package 120 and the set of gate lines 126 extending from a second gate semiconductor chip package 120, may be bent again by about 90 degrees, and may then extend in a direction perpendicular to the first side of the TFT panel 111 and towards the first side of the TFT panel 111. The third and fourth, and any subsequent gate driving signal transmission lines 101c, 101d may be similarly formed, although the last set of gate driving signal transmission lines 101d need not have the second bend of about 90 degrees.

The first data semiconductor chip package 132 is used for receiving both gate and data driving signals, and the second data semiconductor chip packages 133 are used exclusively for receiving data driving signals.

Here, the first data semiconductor chip package 132 includes a plurality of driving signal transmission interconnections 135 and a data integrated chip (“IC”) 138 which is electrically connected to at least some of the driving signal transmission interconnections 135.

In this case, the data IC 138 of the first data semiconductor chip package 132 is mounted on a base film 139 using a flip-chip method, a chip packaging technique in which the active area of the chip is flipped over to face downward. Some of the driving signal transmission interconnections 135 which are not connected to the data IC 138 but connected to the first gate driving signal transmission lines 101a formed on the TFT panel 111 transmit a plurality of gate driving signals output from the integrated PCB 130 to the gate semiconductor chip packages 120. Some of the driving signal transmission interconnections 135 which are connected to the data IC 138 and to the data lines 134 formed on the TFT panel 111 transmit a data driving signal output from the integrated PCB 130 to TFTs connected between the gate lines 126 and the data lines 134, as will be further described below with respect to FIG. 4.

In addition, each of the second data semiconductor chip packages 133 includes a plurality of driving signal transmission interconnections 137 and a data IC 138 which is electrically connected to the driving signal transmission interconnections 137. The data IC 138 of each of the second data semiconductor chip packages 133, like the data IC 138 of each of the first data semiconductor chip packages 132, is mounted on the base film using a flip-chip method.

The transmission of signals from the integrated PCB 130 to the data semiconductor chip packages 132, 133 and to the gate semiconductor chip packages 120 will now be further described.

When an image signal output from an external data processing device, e.g., a computer, is input to the integrated PCB 130, the timing control unit 10 of FIG. 1, which is formed on the integrated PCB 130, generates first control signals for controlling the display of the input image signal, RGB image data (hereinafter referred to as the data driving signal), and second control signals for controlling the gate lines 126. Here, the first control signal include a load signal LOAD or TP and a horizontal synchronization start signal STH, and the second control signal include a gate selection signal Gate CLK or CPV, a vertical synchronization start signal STV, and an output enable signal OE. The gate voltage generation unit 40 of FIG. 1, which is formed on the integrated PCB 130, provides a gate-on voltage Von and a gate-off voltage Voff to the gate semiconductor chip packages 120. Here, the second control signals, the gate-on voltage Von, and the gate-off voltage Voff are referred to as the gate driving signals.

The data driving signal generated by the timing control unit 10 on the integrated PCB 130 is input to the data IC 138 of the first data chip package 132 via the driving signal transmission interconnections 135 and is processed by the data IC 138 of the first data chip package 132. In addition, the data driving signal generated by the timing control unit 10 is input to the data IC 138 of each of the second data chip packages 133 via the driving signal transmission interconnections 137 and is processed by the data IC 138 of each of the second data chip packages 133. The processed results are input to the data lines 134 formed on the TFT panel 111 via the driving signal transmission interconnections 135 and 137. Although the data lines 134 are illustrated as grouped into six sets on a non-effective display region of the TFT panel 111, it should be understood that the data lines 134 diverge in the display region of the TFT panel 111, hidden from view by the color filter panel 112.

While the data driving signal is input to and processed by the first and second data semiconductor chip packages 132 and 133, the gate driving signals generated by the timing control unit 10 on the integrated PCB 130 are input to the first gate driving signal transmission lines 101a via the driving signal transmission interconnections 135 of the first data semiconductor chip package 132 to which the first gate driving signal transmission lines 101a are connected.

Thereafter, the gate driving signals are input to a plurality of bypass lines 125, connected to a first set of the first gate driving signal transmission lines 101a, and are transmitted to the second gate driving signal transmission lines 101b bypassing a gate IC 140.

The gate driving signals transmitting through a plurality of input interconnections 122, connected to a second set of the first gate driving signal transmission lines 101a, are transmitted to the gate IC 140 of the gate semiconductor chip package 120. The gate driving signals received by the gate IC 140 are converted into output signals, and are transmitted to the gate lines 126 on the TFT panel 111 via a plurality of first output interconnections 123.

The gate driving signals transmitting from the gate IC 140 through second output interconnections 124 are output to the second gate signal transmission lines 101b so that they can be used for driving the subsequent gate semiconductor chip package 120 to which the second gate signal transmission lines 101b are connected.

In this manner, the gate driving signals output from the integrated PCB 130 can be consecutively transmitted from a gate IC 140 of one gate semiconductor chip package 120 to a gate IC 140 of another gate semiconductor chip package 120.

When gate output signals are applied to a group of gate lines 126 on the TFT panel 111, a series of TFTs corresponding to the group of gate lines 126 are all turned on in response to the gate output signals, and thus, a voltage applied to a data IC 138 corresponding to the TFTs that are turned on is quickly output to pixel electrodes connected to each of the TFTs, respectively. As a result, an electric field is formed between the pixel electrodes on the TFT panel 111 and a common electrode on the color filter panel 112. Due to the electric field, the arrangement of liquid crystal molecules in the liquid crystal layer interposed between the color filter panel 112 and the TFT panel 111 is altered, and image information regarding this alteration is displayed.

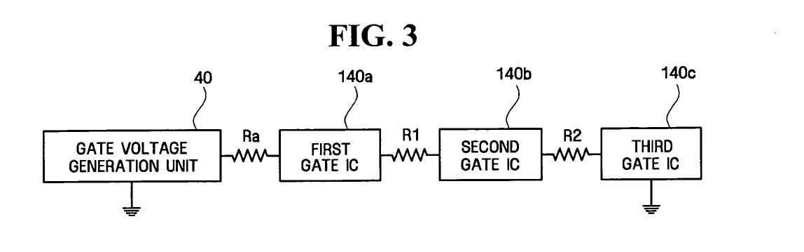

FIG. 3 is a block diagram for explaining the relationships between an exemplary gate voltage generation unit of FIG. 1 and a plurality of exemplary gate (“ICs”) of FIG. 2. Referring to FIG. 3, the gate voltage generation unit 40 of FIG. 1, which may be included on the integrated PCB 130, transmits a gate driving signal, particularly a gate-off voltage Voff, to first through third gate ICs 140a through 140c via a gate driving signal transmission line. In the present embodiment, the gate voltage generation unit 40 is illustrated as transmitting the gate driving signal to three gate ICs, however the number of gate ICs to which the gate voltage generation unit 40 can transmit the gate driving signal may be altered according to the type of LCD including the gate voltage generation unit 40.

In the LCD according to an exemplary embodiment of the present embodiment from which a gate PCB is removed, the greater the distance between the first through third gate ICs 140a through 140c, the greater the length of gate driving signal transmission lines 101a, 101b, 101c connecting the gate voltage generation unit 40 to the first gate IC 140a, connecting the first gate IC 140a to the second gate IC 140b, and connecting the second gate IC 140b to the third gate IC 140c, respectively, and the greater the resistances Ra, R1, and R2 of the gate driving signal transmission lines 101a, 101b, 101c. Therefore, the gate-off voltage Voff provided by the gate voltage generation unit 40 may be distorted in the process of being transmitted from the first gate IC 140a to the second gate IC 140b and from the second gate IC 140b to the third gate IC 140c. Here, the gate driving signal transmission lines 101a, 101b, 101c with the resistances Ra, R1, and R2 may be interconnections via which a gate-on voltage Von or the gate-off voltage Voff is transmitted.

The relationship between the distortion of a gate-off voltage Voff and the display characteristics of an exemplary LCD will now be described with reference to FIG. 4. FIG. 4 is a circuit diagram of an exemplary TFT included in an exemplary liquid crystal panel according to an exemplary embodiment of the present invention.

The liquid crystal panel 110 includes a matrix of pixel regions defined by intersecting gate lines 126 and data lines 134. Referring to FIG. 4, each pixel includes a switching device Q connected to a data line Dj and a gate line Gi, a liquid crystal capacitor Clc connected to the switching device Q, and a storage capacitor Cst connected to the liquid crystal capacitor Clc. In alternative embodiments, the storage capacitor Cst may not be formed.

The switching device Q may be a TFT formed on the TFT panel 111 and is a tri-terminal device having a control terminal (a gate electrode) connected to the gate line Gi, an input terminal (a source electrode) connected to the data line Dj, and an output terminal (a drain electrode) connected to the liquid crystal capacitor Clc and the storage capacitor Cst. A gate signal is applied to the gate line Gi and therefore transmitted to the control terminal of the TFT.

The liquid crystal capacitor Clc uses a pixel electrode of the TFT panel 111 and a common electrode of the color filter panel 112 as its terminals, and a liquid crystal layer between the pixel electrode and the common electrode serves as a dielectric material. The pixel electrode is connected to the output terminal (drain electrode) of the switching device Q. The common electrode is formed on the surface of the color filter panel 112 facing the TFT panel 111, and a common voltage Vcom is applied to the common electrode. While the common electrode has been described as formed on the color filter panel 112, the common electrode may instead be formed on a lower display panel, in which case, at least one of the pixel electrode and the common electrode may be shaped in a line or a strip.

The storage capacitor Cst, which assists the liquid crystal capacitor Clc, is formed by overlapping a storage electrode line on the TFT panel 111 and the pixel electrode with a dielectric material interposed therebetween. A constant voltage, e.g., the common voltage Vcom, is applied to the storage electrode line.

If the pixel is defective, a parasitic capacitor Cg_pix may be formed by overlapping a previous gate line Gi-1 and a pixel electrode with a dielectric material interposed therebetween in order to fix the pixel.

In this case, the variation in the voltage Vp of the pixel electrode according to distortion of a gate-off voltage Voff applied to the previous gate line Gi-1 can be calculated as represented by:

$$Δ {V}_{p} = \frac{Cg\_pix}{Clc + Cst + Cg\_pix} \times ( \frac{Δ Voff}{2} )$$

where ΔVp is the variation in the voltage Vp of the pixel electrode, and ΔVoff is the degree to which the gate-off voltage Voff applied to the previous gate line Gi-1 is distorted. As represented by the above Equation, ΔVp is determined by the capacitance of the parasitic capacitor Cg_pix and ΔVoff. Here, the capacitances of the parasitic capacitor Cg_pix, the liquid crystal capacitor Clc, and the storage capacitor Cst are determined by the pixel design and thus are maintained constant. Therefore, ΔVp, the variation in the voltage Vp of the pixel electrode, which determines the display characteristics of the LCD, is determined by the degree ΔVoff to which the gate-off voltage Voff applied to the previous gate line Gi-1 is distorted.

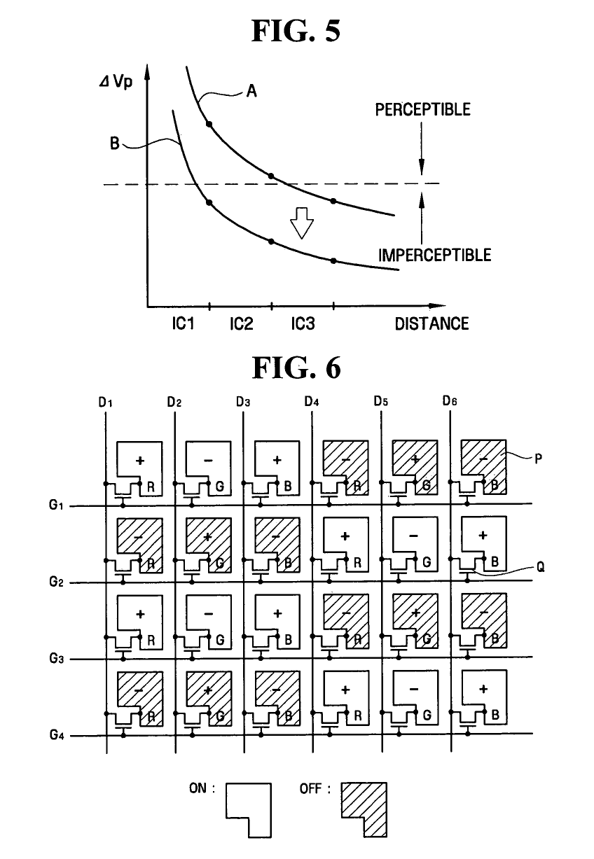

FIG. 5 is a graph illustrating the variation ΔVp of pixel electrode voltages Vp for a plurality of gate ICs with different resistances between the gate voltage generation unit 40 and the first gate IC 140a of FIG. 3. Specifically, a curve A of FIG. 5 illustrates the variation ΔVp in a pixel electrode voltage Vp among a plurality of gate ICs IC1, IC2, IC3 included in a conventional LCD, and a curve B of FIG. 5 illustrates the variation ΔVp in a pixel electrode voltage Vp among a plurality of gate ICs IC1, IC2, IC3 included in an exemplary LCD according to an exemplary embodiment of the present invention. Referring to FIG. 5, reference characters ICI through IC3 may correspond to the first through third gate ICs 140a through 140c, respectively, of FIG. 3.

Referring to FIGS. 3 through 5, the resistances R1 and R2 of gate driving signal transmission lines between the first and second gate ICs IC1 and IC2 and between the second and third gate ICs IC2 and IC3, respectively, are determined according to the size of a liquid crystal panel including the first through third gate ICs IC1 through IC3, the locations of the first through third gate ICs IC1 through IC3, and the material of the gate driving signal transmission lines and are maintained constant. For example, the resistance R1 may be approximately 9Ω, and the resistance R2 may be approximately 10Ω.

The curve A can be obtained when the resistance Ra of a gate driving signal transmission line between a gate voltage generation unit and the first IC IC1 is approximately 15Ω, which is less than a sum of the resistance R1 and the resistance R2.

The curve B can be obtained when the resistance Ra is higher than the sum of the resistances R1 and R2. For example, the curve B can be obtained when the resistance Ra is approximately 20Ω.

When the resistance Ra of a gate driving signal transmission line between the gate voltage generation unit 40 and the first gate IC 140a is approximately 15Ω, which is less than a sum of the resistances R1 and R2, then the variation ΔVp in the pixel electrode voltage Vp between the gate voltage generation unit 40 and the first through third gate ICs 140a through 140c may fall in the perceptible zone, thus generating horizontal stripes on a display panel. However, when the resistance Ra of the gate driving signal transmission line between the gate voltage generation unit 40 and the first gate IC 140a is approximately 20Ω, which is greater than a sum of the resistances R1 and R2, then the variation ΔVp in the pixel electrode voltage Vp between the gate voltage generation unit 40 and the first through third gate ICs 140a through 140c may fall in the imperceptible zone, thus preventing horizontal stripes from being generated on the display panel.

As illustrated in FIG. 5, if the resistance Ra is determined to be higher than the sum of the resistances R1 and R2 by, for example, installing an additional resistor between the gate voltage generation unit and the first gate IC IC1, the pixel electrode voltage among the first through third gate ICs IC1 through IC3 may vary, but the variance may not be perceptible by viewers, because a gate-off voltage Voff is distorted before input to the first gate IC IC1, thus reducing the degree to which the gate-off voltage Voff is distorted. Therefore, preferably, but not necessarily, the resistance Ra may be higher than the sum of the resistances R1 and R2.

The gate driving signal transmission line, e.g. 101a as shown in FIG. 2, between the gate voltage generation unit 40 and the first gate IC 140a is illustrated in FIG. 3 as including only a resistor with the resistance Ra but may also include a capacitor connected in parallel to the resistor. The capacitor may stabilize a load applied to an input terminal of the first gate IC 140a.

In a case where an additional resistor is installed between the gate voltage generation unit 40 and the first gate IC 140a, it may be formed on the integrated PCB 130 or the liquid crystal panel 110, such as within the non-display region of the TFT panel 111.

The resistance Ra of the gate driving signal transmission line 101a between the gate voltage generation unit 40 and the first gate IC 140a may be altered according to the type of the LCD and may be within the range of about 20-3000Ω.

In a 1-dot on/off pattern test, as further described below with respect to FIG. 6, no horizontal stripes are found on the exemplary LCD according to an exemplary embodiment of the present invention.

FIG. 6 is a circuit diagram of a 1-dot on/off pattern. In a 1-dot on/off pattern test, pixels of an LCD are divided into a plurality of groups each consisting of 3 consecutive horizontal pixels (RGB), and the pixel groups are alternately turned on and off so that a pair of vertically or horizontally adjacent pixel groups are not both on or off. Pixel groups whose pixel electrodes P are turned on by switching devices Q are illustrated as being bright by not including shading, and pixel groups whose pixel electrodes P are turned off by switching devices Q are illustrated as being dark by including shading. Reference characters G1, G2, G3, and G4 represent gate lines, reference characters D1, D2, D3, and D4 represent data lines, and signs + and − indicate positive and negative polarities, respectively, of pixel voltages Vp. In the present embodiment, a dot inversion driving method may be used.

As described above, according to the present invention, it is possible to improve the display characteristics of an LCD by preventing horizontal stripes from being generated on the LCD.

In concluding the detailed description, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation.

What is claimed is:

1. A liquid crystal display device comprising:
a liquid crystal panel displaying image data;
a plurality of gate integrated circuits connected to a first side of the liquid crystal panel;
a plurality of data integrated circuits connected to a second side of the liquid crystal panel, the second side of the liquid crystal panel adjacent to the first side of the liquid crystal panel;
a gate voltage generation unit providing one of a gate-on voltage and a gate-off voltage to the gate integrated circuits; and
a plurality of gate driving signal transmission lines connecting the gate voltage generation unit and the gate integrated circuits and connecting the gate integrated circuits to one another, wherein a resistance of a gate driving signal transmission line connecting the gate voltage generation unit and a gate integrated circuit closest to the gate voltage generation unit is greater than a sum of resistances of remaining gate driving signal transmission lines.

2. The liquid crystal display of claim 1, wherein the plurality of gate integrated circuits includes first, second, and third gate integrated circuits, and the plurality of gate driving signal transmission lines includes a first gate driving signal transmission line connecting the gate voltage generation unit to the first gate integrated circuit, a second gate driving signal transmission line connecting the first gate integrated circuit to the second gate integrated circuit, and a third gate driving signal transmission line connecting the second gate integrated circuit to the third gate integrated circuit, the resistance of the first gate driving signal transmission line less than a sum of the resistances of the second and third gate driving signal transmission lines.

3. The liquid crystal display of claim 1, wherein the resistance of the gate driving signal transmission line connecting the gate voltage generation unit and the gate integrated circuit closest to the gate voltage generation unit is within a range of 20-3000Ω.

4. The liquid crystal display of claim 1, wherein the plurality of gate driving signal transmission lines transmit the gate-on voltage and the gate-off voltage provided by the gate voltage generation unit to the gate integrated circuits.

5. The liquid crystal display of claim 1, wherein a resistor is attached to the gate driving signal transmission line connecting the gate voltage generation unit and the gate integrated circuit closest to the gate voltage generation unit, the resistor providing additional resistance between the gate voltage generation unit and the gate integrated circuit closest to the gate voltage generation unit.

6. The liquid crystal display of claim 5, wherein the resistor is formed on an integrated printed circuit board connected to the data integrated circuits and located on the second side of the liquid crystal panel.

7. The liquid crystal display of claim 6, wherein the gate voltage generation unit is provided on the integrated printed circuit board.

8. The liquid crystal display of claim 5, wherein the resistor is formed on the liquid crystal panel.

9. The liquid crystal display of claim 5 further comprising a capacitor connected in parallel to the resistor and stabilizing a load applied to an input terminal of the gate integrated circuit closest to the gate voltage generation unit.

10. The liquid crystal display of claim 1, wherein the gate integrated circuits are mounted on the liquid crystal panel using a chip-on-glass method.

11. The liquid crystal display of claim 1, wherein the gate integrated circuits are mounted on the liquid crystal panel using a tape automated bonding method.

12. The liquid crystal display of claim 1, wherein the gate integrated circuits are bonded onto a flexible printed circuit board using one of a tape carrier package method and a chip on film method, wherein the flexible printed circuit board is bonded to the liquid crystal panel.

13. The liquid crystal display of claim 1, wherein a plurality of gate driving signals are applied from an integrated printed circuit board to the gate integrated circuits via a driving signal transmission interconnection and the liquid crystal panel, and the integrated printed circuit board is connected to the data integrated circuits and is located on the second side of the liquid crystal panel.

14. The liquid crystal display of claim 13, wherein the driving signal transmission interconnection is provided on a first data semiconductor chip package including a first data integrated circuit.

15. A liquid crystal display device comprising:
a plurality of gate integrated circuits; and,
a gate voltage generation unit connected to a first gate integrated circuit, and connected to a remainder of the plurality of gate integrated circuits via the first gate integrated circuit;
wherein a resistance between the first gate integrated circuit and the gate voltage generation unit is greater than a sum of resistances of connections between adjacent gate integrated circuits.

16. The liquid crystal display device of claim 15, further comprising a first gate driving signal transmission line connecting the gate voltage generation unit to the first gate integrated circuit and a plurality of chip-interconnecting gate driving signal transmission lines connecting adjacent gate integrated circuits to each another, wherein a resistance of the first gate driving signal transmission line is greater than a sum of resistances of the chip-interconnecting gate driving signal transmission lines.

17. The liquid crystal display device of claim 15 further comprising a first gate driving signal transmission line connecting the gate voltage generation unit to the first gate integrated circuit and a resistor attached to the first gate driving signal transmission line.

18. The liquid crystal display device of claim 17 further comprising a capacitor connected in parallel to the resistor.

19. A method of improving display characteristics of a liquid crystal display, the method comprising:
arranging chip-interconnecting gate driving signal transmission lines between adjacent gate integrated circuits; and,
providing a connection between a first gate integrated circuit and a gate voltage generation unit with a resistance greater than a sum of resistances of the chip-interconnecting gate driving signal transmission lines.

20. The method of claim 19, wherein providing the connection with a resistance greater than a sum of resistances of the chip-interconnecting gate driving signal transmission lines includes attaching a resistor to a first gate driving signal transmission line connecting the first gate integrated circuit and the gate voltage generation unit.
